(19) United States
(12) Patent Application Publication
(10) Pub. No.: US 2018/0030344 A1
(43) Pub. Date: Feb. 1, 2018

(54) NOVEL COMPOSITE OF SILICA AND GRAPHENE QUANTUM DOTS AND PREPARATION THEREOF

(71) Applicant: Council of Scientific and Industrial Research, New Delhi (IN)

(72) Inventors: Pankaj Poddar, Maharashtra (IN); Subha Sadhu, Maharashtra (IN)

(21) Appl. No.: 15/548,708

(22) PCT Filed: Feb. 3, 2016
(86) PCT No.: PCT/IN2016/050040

§ 371 Date: Aug. 3, 2017

(30) Foreign Application Priority Data
Feb. 3, 2015 (IN) 307/DEL/2015

(51) Int. Cl. C09K 11/65

(52) U.S. Cl. CPC C09K 11/655; B82Y 20/00

(57) ABSTRACT

The present invention relates to a novel composite of graphene quantum dot and silica. The present invention further relates to a novel one step process for the synthesis of composite of GQD and silica from paper. The composite is useful for biological applications such as bioimaging, drug delivery etc.

### FIELD OF THE INVENTION

The present invention relates to a novel composite of graphene quantum dot and silica. The present invention further relates to a novel one step process for the synthesis of composite of GQD and silica from paper.

### BACKGROUND AND PRIOR ART

GQD from paper is not known, but GQD from any C-source is known. The synthesis of this size of GQD with fluorescence is also known from egg shells, other chemicals etc. It is a very challenging task to synthesize fluorescent graphene quantum dot—silica composite by simple one step and biocompatible method. Prior art processes reported uses hydrothermal or chemical vapour deposition process.

Till now various methods have been used for the synthesis of GQDs. But as per our knowledge GQD-SiO₂ composite material have not been synthesized yet. The synthesis of GQD can be classified into top down and bottom up approaches. Top down methods include, electron beam lithography, acidic exfoliation, electrochemical oxidation, microwave-assisted hydrothermal synthesis, solvothermal method etc. Bottom-up routes include the solution chemistry, cyclodehydrogenation of polyphenylene precursors, carbonizing some special organic precursorsor etc.

Chinese Pat. No. 104229779 discloses recyclable graphene which comprises the following substances in parts by weight: 13-27 parts of carbon monofluoride, 11-23 parts of a hexa-bromine water dispersed body, 13-28 parts of methyl allyl cyclohexene, 10-14 parts of quartz sand, 15-36 parts of methanol, 75-80 parts of graphite, 5-8 parts of butyryltrihexylcitrate, 15-27 parts of nonyl hexyl trimellitate, 1-5 parts of coal ash, 50-77 parts of diethylene glycol benzoate and 78-80 parts of water.

Chinese pat. No. 102903541 discloses method for preparing graphene-based electrode material for super-capacitor. a method for preparing a graphene-based composite material for a super-capacitor on the basis of an electrostatic spray deposition technology, and belongs to the field of storage of new generation of energy. The method comprises the following steps of: (1) cleaning a current collector, and placing the current collector on a heating plate; (2) dispersing an aqueous solution and an active material of oxidized graphene in a mixed solution consisting of water, ethanol, ethylene glycol and propylene glycol, stiffing the mixture, performing ultrasonic treatment on the mixture, uniformizing the mixture and then transferring the mixture to a syringe; and (3) adding a high-voltage electrostatic field between the syringe and a base plate, feeding liquid at the pushing speed of 3-15 ml/h, keeping the heating temperature of the heating plate in a range of 200-300 DEG C, and depositing the mixture for 2-10 hours so as to obtain a graphene-active material/current collector composite material.

Chinese Pat. No. 103910492 discloses a graphene compound glass as well as a preparation method and an application of the compound glass. A graphene composite glass, wherein: the material graphene composite glass is bulk material graphene material and gel glass matrix composed of different dimensions; the two-dimensional material graphene, graphene nanosheets, nano graphene oxide sheets, one-dimensional graphene nanoribbons and graphene oxide nanoribbons, or zero-dimensional graphene quantum dot, per mole of SiO₂ doped graphene materials should not exceed 24 mg. The diameter of the zero-dimensional graphene quantum dots of less than 20 nm.

European Pat. No. 2585403 discloses methods of forming graphene by graphite exfoliation. A method of forming graphene, comprising: providing a graphite sample having atomic layers of carbon with spaces in between; introducing a solvent and ions into the spaces between the atomic layers; expanding the space between the atomic layers using at least one of the solvent and the ions; and separating the atomic layers using a driving force to form one or more sheets of graphene. The driving force is at least one of: electrochemical, thermal, microwave, solvothermal, sonochemical and acoustic. The graphene-based asymmetric heterojunction as CdTe/graphene/PbS—TiO₂ or CdSe/graphene/PbS—TiO₂.

Article titled “An approach to controlling the fluorescence of graphene quantum dots: From surface oxidation to fluorescent mechanism” by Hu Yin et al. published in Chinese Physics B, 2014, 23(12), pp 128103-1 to 128103-7 reports a facile method of synthesizing graphene quantum dots (GQDs) with tunable emission. The as-prepared GQDs each with a uniform lateral dimension of ca. 6 nm have fine solubility and high stability. Flake graphite (3.0 g) was added to concentrated sulfuric acid (300 mL) at room temperature under mechanical stirring, then NaNO₃ (43.0 g) was added; afterwards, the mixture was cooled down to 0° C. KMnO₄ (3.0 g) was added slowly under vigorous agitation to keep the temperature of the suspension lower than 20° C.

Successively, a 40-° C. water bath was applied to the reaction system and stirred for about 40 minutes. The mixture was further treated under mild ultrasound (150 W) for 3 h. After ultrasound, the reagents turned into an ash black paste. The paste was then diluted with deionized water (200 mL) and converted into a bright brown suspension liquid. The pH value of the diluted solution was adjusted to 7 using Na₂CO₃ followed by filtration through a 220-nm polytetrafluoroethylene (PTFE) microporous membrane before the seeds come out of the oversaturated sulphate and a brown filter solution was then separated. Finally, the solution was dialyzed in a dialysis bag (cut off molecular weight 3500D) in deionized water for 3 days. After the purification, a clear solution with a very light brown color could be obtained. For modulating the properties of GQDs, the ultrasound power in the experimental phase is varied from 60 W to 150 W.

Article titled “Simple one-step synthesis of water-soluble fluorescent carbon dots derived from paper ash” by Jumeng Wei et al. published in Royal Society of Chemistry Advances, 2013, 3, 13119-13122 reports highly photoluminescent carbon dots with a PL quantum yield of 9.3% have been prepared via a simple one-step synthesis route using waste paper as a novel carbon source.

Article titled “Facile ultrasonic synthesis of CoO Quantum Dot/Graphene nanosheet composites with high Lithium storage capacity” by Chengxin Peng et al. published in ACS Nano, 2012, 6 (2), pp 1074-1081 reports a facile ultrasonic method to synthesize well-dispersed CoO quantum dots (3-8 nm) on graphene nanosheets at room temperature by employing Co₄(CO)₁₂ as cobalt precursor.

Article titled “Organosilane-functionalized graphene quantum dots and their encapsulation into bi-layer hollow silica spheres for bioimaging application” by Yonggang Wang et al. published in Physical Chemistry Chemical Physics, 2014; 16(42) reports organosilane-functionalized graphene quantum dots and their encapsulation into bi-layer hollow silica spheres for bioimaging applications. The facile fabrication of fluorescent organosilane-functionalized graphene quantum dots (Si-GQDs) and their embedding into mesoporous hollow silica spheres as a biolabel for the first time. Well-proportioned Si-GQDs with bright and excitation dependent tunable emissions in the visible region were obtained via a simple and economical solvothermal route adopting graphite oxide as a carbon source and 3-(2-aminoethylamino)-propyltrimethoxysilane as a surface modifier.

Article titled “Carbon quantum dots: synthesis, properties and applications” by Youfu Wang et al. published in Journal of Material Chemistry C, 2014, 2, pp 6921-6939 reports different synthetic methods used for the preparation of CQDs like Chemical ablation, Electrochemical carbonization, Laser ablation, Microwave irradiation, Hydrothermal/solvothermal treatment.

Article titled “Graphene-quantum-dot nonvolatile charge-trap flash memories” published in Coverage of Disruptive Science and Technology reports Graphene-quantum-dot nonvolatile charge-trap flash memories. The researchers prepared graphene quantum dots of three different sizes (6, 12, and 27 nm diameters) between silicon dioxide layers. The researchers found that the memory properties of the dots differ depending on their sizes. For instance, while the 12-nm dots exhibit the highest program speed, the 27-nm dots exhibit the highest erase speed, as well as the highest stability.

Article titled “Uniform Graphene Quantum Dots patterned from self-assembled silica nanodots” by Jinsup Lee et al. published in Nano Letters 11/2012; 12(12) reports the size-controlled fabrication of uniform GQDs using self-assembled block copolymer (BCP) as an etch mask on graphene films grown by chemical vapor deposition (CVD). Electron microscope images show that as-prepared GQDs are composed of mono- or bilayer graphene with diameters of 10 nm and 20 nm, corresponding to the size of BCP nanospheres. In the measured photoluminescence (PL) spectra, the emission peak of the GQDs on the SiO₂ substrate is shown to be at ˜395 nm.

Article titled “Graphene quantum dot-capped mesoporous silica nanoparticles through an acid-cleavable acetal bond for intracellular drug delivery and imaging” by Tao Chen et al. published in Journal of Material Chemistry B, 2014, 2, 4979 reports Luminescent graphene quantum dots (GQDs) have been capped onto the nanopores of mesoporous silica nanoparticles (MSNs) through an acid-cleavable acetal bond.

Article titled “Silica-covered Au nanoresonators for fluorescence modulating of a graphene quantum dot” by Wang Su-Feng et al. published in Chinese Physics B, 2014, 23 (9), pp 097803 reports synthesis of GQD. The multilayer GO sheets were ultrasonically exfoliated into monolayer GO sheets in an ultrasonic cleaner within 10 h. The monolayer GO sheets were then thermally reduced into expanded grahene sheets (GSs) at 600° C. within 2 h in a nitrogen atmosphere. The GSs were oxidized in concentrated H₂SO₄ and HNO₃. 10 mL concentrated H₂SO₄ and 30 mL HNO₃ were added to 5 mg GSs, and the mixture was under ultrasonic conditions in the ultrasonic cleaner for 18 h. After the oxidization, the mixture was centrifuged several times to remove the acids. Finally, the oxidized GSs needed to be deoxidized. The oxidized GSs were added into 40 mL deionized water adjusting with 4 mL NH₃.H₂O to pH >12 and hydrothermally treated in a polytetrafluoroethylene teflon-lined autoclave (50 mL) at 200° C. for 10-12 h. After being cooled down to the room temperature, the product was filtered through a 0.22 mm microporous membrane, and then centrifuged. The final product was graphene quantum dots. 2 mL GQDs were mixed with 100 μL Au@SiO₂ nanoparticles. Then the mixture was shaken for 1 min.

Article titled “Interfacing water soluble nanomaterials with fluorescence chemosensing: Graphene quantum dot to detect Hg₂ in 100% aqueous solution” by Himadri Chakraborti et al. published in Materials Letters, 2013, 97, 78-80 reports GQDs were prepared by tailoring the carbonization degree of citric acid and dispersing the carbonized products into alkaline solution.

Article titled “Graphene Quantum Dots derived from carbon fibers” by Juan Peng et al. published in Nano Letter, 2012, 12 (2), pp 844-849 reports during the acid treatment and chemical exfoliation of traditional pitch-based carbon fibers, that are both cheap and commercially available, the stacked graphitic submicrometer domains of the fibers are easily broken down, leading to the creation of GQDs with different size distribution in scalable amounts. The as-produced GQDs, in the size range of 1-4 nm, show two-dimensional morphology, most of which present zigzag edge structure, and are 1-3 atomic layers thick.

Article titled “Microwave-assisted synthesis of carbon nanodots through an eggshell membrane and their fluorescent application” by Wang Q et al. published in Analyst, 2012, 137(22) pp 5392-7 reports a “green”, rapid, eco-friendly and waste-reused approach to synthesize fluorescent and water-soluble C-Dots from eggshell membrane (ESM) ashes according to a microwave-assisted process.

Therefore, there is the need to develop one step cost-effective facile microwave process for the synthesis of green luminescent graphene quantum dots—silica composite and their applications.

### OBJECTIVE OF THE INVENTION

The main objective of the present invention is to provide a novel composite of graphene quantum dot and silica, wherein the weight ratio of Graphene Quantum Dots: Silica in the said composite is 5:2.

The another objective of the present invention is to provide a novel composite of Graphene Quantum Dot and silica, wherein said GQD is luminescent and size is in the range of 4-6 nm; size of said silica is in the range of 40-50 nm.

Yet another objective of the present invention is to provide a novel one step process for the synthesis of composite of GQD and silica from paper.

Still another objective of the present invention is to provide process for preparation of biocompatible, green fluorescent graphene quantum dot-silica composite without using any harsh chemical.

Still yet another objective of the present invention is to provide very cheap process for the synthesis of composite of GQD and silica and the product can be synthesized in a very short time i.e. less than one hour.

Still yet another objective of the present invention is to provide the bright photoluminiscence and low cytotoxicity which renders material suitable for biological applications such as bioimaging, drug delivery etc.

Still yet another objective of the present invention is to provide the GQD-silica composite material, which can be used in photocatalysis and photovoltaic devices.

### SUMMARY OF THE INVENTION

Accordingly, the present invention provides a novel composite of graphene quantum dot and silica, wherein the weight ratio of graphene Quantum Dots: Silica in the said composite is 1-5: 1-2 which depends on the source of the paper.

In an embodiment, said GQD is luminescent and size is in the range of 4-6 nm; size of silica is in the range of 40-50 nm confirmed from the TEM micrographs.

In another embodiment, the present invention provides a novel composite, wherein said composite can be prepared from paper, wood pulp, leaves, bananas, coconut peel, coal or cotton.

In yet another embodiment, the present invention provides a novel one step process for the synthesis of composite of GQD and silica from paper comprising the steps of:
a) burning the paper to afford ash;
b) suspending the ash of step (a) in water by sonicating and adding oxidizing agent followed by microwave for 2-4 minutes and repeating the microwave heating for six to seven times at 750 watts to afford a black residue of GQDs silica composite, with green fluorescence.

In still another embodiment, said oxidizing agent is selected from glycolic acid, citric acid and ascorbic acid.

In still yet another embodiment, the main chemical component of said paper is silicate of magnesia wherein the amount of silica is 62-70%.

In still yet another embodiment, said water is de-ionized water.

### LIST OF ABBREVIATIONS

### GQD: Graphene Quantum Dot

### TEM: Transmission Electron Microscopy

TGA: The thermogravimetric analysis

### C-Cot: Carbon Dot

GQD-SiO₂: Graphene Quantum Dot-Silica (Silicon dioxide)

### NaOH: Sodium Hydroxide

### UV: Ultra Violet

### BRIEF DESCRIPTION OF THE DRAWINGS

FIG. 1 depicts TGA of GQD-SiO₂ composite

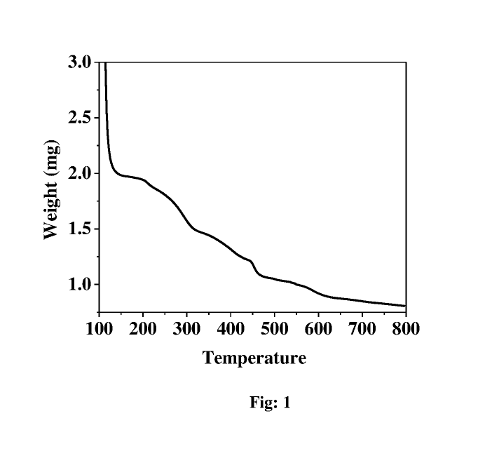

FIG. 2 depict (A) and (B) the TEM images of GQDs which are well dispersed in the size range of ˜4-6 nm. The GQDs are uniformly distributed without agglomeration and are circular. Figure (C) and (D) shows the TEM images of well discrete silica particles within the size range ˜40-60 nm.

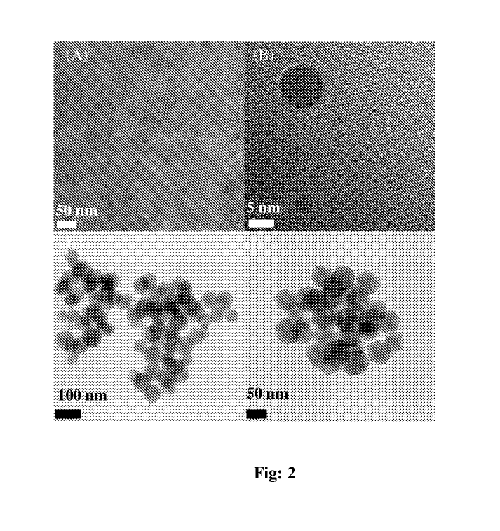

FIG. 3 depicts UV-visible spectra of the as-synthesized GQD-SiO₂ composite. Inset shows the photograph of green luminescent GQDs observed under UV lamp

### DETAILED DESCRIPTION OF THE INVENTION

The invention will now be described in detail in connection with certain preferred and optional embodiments, so that various aspects thereof may be more fully understood and appreciated.

The present invention provides a novel composite of Graphene Quantum Dot and silica, wherein the weight ratio of Graphene Quantum Dots: Silica in the said composite is 1-5: 1-2.

In an embodiment the present invention provides a novel composite, wherein said composite is from paper, wood pulp, leaves, bananas, coconut peel, coal or cotton.

In another embodiment, said GQD is luminescent and size is in the range of 4-6 nm; size of silica is in the range of 40-50 nm.

In yet another embodiment, the present invention provides a novel one step process for the synthesis of composite of GQD and silica from paper comprising the steps of:
a) Burning the paper to afford ash;
b) Suspending the ash of step (a) in water by sonicating and adding oxidizing agent followed by heating in a microwave for 2-4 minutes and repeating the microwave heating for six to seven times at 750 watts to afford a black residue of GQDs silica composite, with green fluorescence.

In still another embodiment, said oxidizing agent is selected from glycolic acid, citric acid and ascorbic acid.

In still yet another embodiment, the main chemical component of said paper is Silicate of magnesia wherein the amount of silica is 62-70%.

In still yet another embodiment, said water is de-ionized water.

The as-synthesized GQD-SiO₂ composite exhibited green fluorescence when illuminated under UV lamp.

To synthesize gqd-silica composite paper was used as a precursor material for the source of carbon and silica. The highly carbon and silica contain material such as leaf; wood pulp etc. can also be used as the precursor material to prepare the composite material. In our experiment, we have only used paper as precursor but the above mentioned precursors also be used as potential material for the biocompatible synthesis.

In the synthesis procedure glycolic acid is used as an oxidizing agent. The main function of the oxidizing agent is to cut off the carbon chain in smaller pieces. Well-controlled oxidation provide break down of graphene to more smooth edges compared to heat or sonic treatment. Thus, similar biocompatible oxidizing agent like ascorbic and citric acid having comparable oxidizing power also work well for the synthesis.

From the TGA data it can be seen that oxidation of grapheme quantum dots take place between 200° C.-600° C. After 750° C. burned out of the entire graphitic carbon take place and after that a linear pattern can be observed which confirms the presence of silica due to its stability in high temperature.

Figure (A) and (B) shows the TEM images of GQDs which are well dispersed in the size range of ˜4-6 nm. The GQDs are uniformly distributed without agglomeration and are circular. Figure (A) and (B) shows the TEM images of well discrete silica particles within the size range ˜40-50 nm.

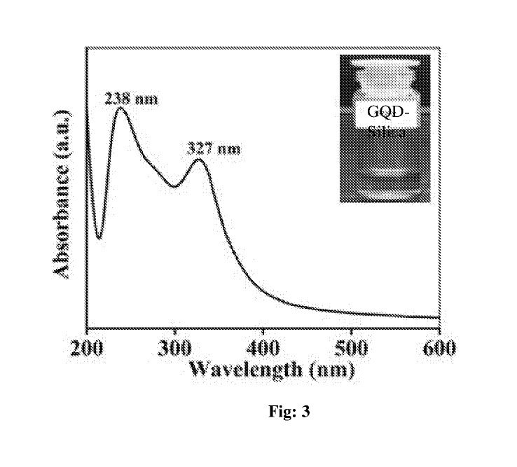

The absorption peak at 238 nm can be assigned to the π-π* transition of aromatic graphitic sp² domains and the strong absorption band appeared ˜327 nm is due to the n-π* transitions of C═O bonds. The GQDs exhibit green fluorescence under UV illumination and also exhibit excellent water dispersibility. (Refer FIG. 3)

The following examples, which include preferred embodiments, will serve to illustrate the practice of this invention, it being understood that the particulars shown are by way of example and for purpose of illustrative discussion of preferred embodiments of the invention.

### Examples

### Example 1: Synthesis of GQD-SiO₂ Composite Material

First the paper was burnt down to ashes in a controlled environment. Then the black ash was crushed well in a mortar pestle. After that, 100 mg ash was weighed and mixed in 50 ml de-ionized water. The solution was sonicated in bath sonicator for 30 minutes. 50 ml solution of 1 g glycolic acid was added drop wise in the sonicated solution. After addition of glycolic acid, the solution was further sonicated for 30 minutes. Then the solution was heated in a microwave at 500 watt for 20 minutes through 10 microwave cycles for 2 minutes. The viscous solution was collected and mixed with 50 ml de-ionized water. The pH of the solution was made ˜7 by mixing NaOH and the solution was ultra-sonicated for 15 minutes and filtrate to obtain a clear bright yellow solution. Further the solution was heated in the microwave at 500 watt for 10 minutes and then diluted in de-ionized water.

Advantages of Invention:
1. Biocompatible, green fluorescent graphene quantum dot-silica composite have been prepared without using any harsh chemical.
2. The preparation method is very cheap and the product can be synthesized in a very short time i.e. less than one hour.
3. The bright photoluminescence and low cytotoxicity render the material for biological applications such as bioimaging, drug delivery etc.
4. Different sensors can be fabricated with GQD-silica composite either signal-off or signal-on processes. Such photoluminescence sensors have been used for metal ion detection like Fe³⁺ etc.
5. The GQD-silica composite material can also be used in photocatalysis and photovoltaic devices.

1. A novel composite of graphene quantum dot and silica in the weight ratio gqd and silica is in the range of 1-5: 1-2 and depend upon source of paper.

2. The composite as claimed in claim 1, wherein said composite is obtained from paper, wood pulp, leaves, bananas, coconut peel, coal or cotton.

3. The composite as claimed in claim 1, wherein said gqd is luminescent and size is in the range of 4-6 nm.

4. The composite as claimed in claim 1, wherein size of said silica is in the range of 40-50 nm.

5. The composite as claimed in claim 1, wherein the main chemical component of said paper is silicate of magnesia wherein the amount of silica is 62-70%.

6. A novel one step process for the synthesis of said composite of gqd and silica as claimed in claim 1 comprising the steps of:
a) burning the paper to afford ash;
b) suspending the ash of step (a) in water by sonicating and adding oxidizing agent followed by heating in a microwave for 2-4 minutes and repeating the microwave heating for six to seven times at 750 watts to afford a black residue of GQDs silica composite, with green fluorescence.

7. The process as claimed in claim 6, wherein said oxidizing agent is selected from glycolic acid, citric acid or ascorbic acid.

8. The process as claimed in claim 6, wherein said paper is silicate of magnesia wherein the amount of silica is 62-70%.

9. The process as claimed in claim 6, wherein said water is de-ionised water.
